(19) United States
(12) Patent Application Publication
(10) Pub. No.: US 2013/0173514 A1
(43) Pub. Date: Jul. 4, 2013

(54) Automated Network Disturbance Prediction System Method & Apparatus

(71) Applicant: Rev2 Networks, Inc., Valhalla, NY (US)

(72) Inventors: Robert F. Cruickshank, III, Big Indian, NY (US); Steve Olyha, New Fairfield, CT (US); Lou Steinberg, New Fairfield, CT (US); John Curtis, Austin, TX (US)

(73) Assignee: REV2 NETWORKS, INC., Valhalla, NY (US)

(21) Appl. No.: 13/730,925

(22) Filed: Dec. 29, 2012

Related U.S. Application Data
(60) Provisional application No. 61/581,688, filed on Dec. 30, 2011.

(51) Int. Cl. G06N 3/08

(52) U.S. Cl. CPC G06N 3/08
USPC 706/20

(57) ABSTRACT

An apparatus and method are provided for generating a prediction warning when an operational disturbance is detected in a computer, software program or in network. A classifying portion classifies problems or outages according to an impact that the problem or the outage has on the computer, software program or network. An analysis portion analyzes data and establishes links between isolated computer, software or network problems or outages, and outputs a likely cost of a future computer, software or network problem or outage. A reporting portion reports the prediction warning in response to the likelihood of the computer, software or future network problem or outage in a format that is selected based on a type of user.

### PRIORITY

The present application claims the benefit of priority to Provisional Application number U.S. 61/581,688, filed Dec. 30, 2011, the entirety of which is incorporated herein by reference for all purposes.

### BACKGROUND

While Multiple System Operators (MSOs) have alerting mechanisms and are equipped to deal with “right now, hard down” critical outages, often smaller and intermittent outages are much harder to detect and can be altogether missed for extended periods of time. Sometimes operators (or subscribers of these operators) notice these intermittent outages, and some of these intermittent outages are the precursors of much larger outages. There are clues that can point operations teams to concentrations of outage risk. However, these clues are too often overlooked because they are not apparent to the operator.

Cable Television MSOs generally detect outages in node-serving areas on an ad hoc basis by looking at isolated risks. For example, subscriber trouble call volume at or above a threshold of, for example, approximately three calls per hour may trigger the MSO to take action. While isolated risk analysis evaluates each standalone tree, it ignores the much larger level of the forest. Additionally, isolated analysis lacks consistency and the ability to assign relative weights to risks, making it hard to compare risks from seemingly unrelated areas.

Furthermore, smaller outages may not only be telling of a future wider spread system-wide breakdown, but also may be damaging to a system's value and goodwill and/or reputation. For that matter, smaller outages may appear as chronic ailments that congest an operator's functions. Due to the aforementioned challenges, smaller outages and pockets of degraded service may go undetected long enough for repeat calls to manifest as complaints to MSO executive management, often resulting in staff ultimately finding and validating an actual subscriber-affecting issue and then regretfully agreeing, “Why didn't we see that earlier?”

Commercial Service customers and premium customers such as customers of triple play for next generation TV, generate much higher revenues than basic cable customers for MSOs. The loss of that customer due to too many intermittent outages here is a bigger hit to long-term revenue. Moreover, there are much higher stakes in the financial services, or manufacturing arena, as the cost associated with each outage are much more severe. If the stock market server goes down, for example, world economies are affected. A stoppage in critical supply chains for semiconductor materials was seen as an effect of the tsunami in Thailand that sent chip manufacturers scrambling to avoid a grinding halt in electronic component production. An interruption of the super bowl on a network wide basis, as another example, would be a catastrophe not only for the program viewers but also the networks, NFL and re-broadcasters.

In addition, the subscribers in these markets are inelastic. Once their faith is broken in a service, they are able and may turn to other providers. Worse, the liability involved with an outage may be a material breach of agreement, tortious negligence, or may even be gross negligence leading to penal sanctioning. The financial crisis of 2008 is a good example of how a combination of bad decisions and unrecognized risks sparked a worldwide economic meltdown. In addition, the speed at which a breakdown can manifest in the digital age can occur at processor speed.

There are few automated solutions currently available. In the cable television space, these are limited to “dumb” processing of low-level “dribbling in” trouble calls and truck rolls over several days or weeks. Likewise, detection exists for multiple Customer Premises Equipment (CPE) devices falling offline (i.e., number of offline devices rising above a certain threshold). However, detection in this area is also quite limited.

### SUMMARY

An apparatus is provided for generating a prediction warning when an operational disturbance is detected in a computer, software program or in a network. A classifying portion classifies problems or outages according to an impact that the problem or the outage has on the computer, software program or network. An analysis portion analyzes data and establishes links between isolated computer, software or network problems or outages, and outputs a likely cost of a future computer, software or network problem or outage. A reporting portion reports the prediction warning in response to the likelihood of the computer, software or future network problem or outage in a format that is selected based on a type of user.

### BRIEF DESCRIPTION OF THE DRAWINGS

FIG. 1 illustrates a possible arrangement of the solution provided and it's components;

FIG. 2 illustrates a network that is applicable to the instant solution;

FIG. 3 illustrates features of different applications

FIGS. 4A to 4C illustrate a report or interface provided by the instant solution; and

FIG. 5A to 5D illustrate another report provided by the instant solution.

### DETAILED DESCRIPTION

The presently described system provides an automated approach that links together seemingly unrelated vulnerabilities and events, is capable of warning human operators of impending or arising outages, and provides a human friendly makes-sense interface that alerts an operator or provider of the risk in sufficient time. In particular, this system provides an automated solution for smaller deviations in offline devices. Additionally, this system may provide linkages and ties among the disparate information which may be in the form of database records of, department and product data, information security data, governance, risk and compliance data, business continuity data, sales data, subscriber calls, truck rolls, or offline devices, for example.

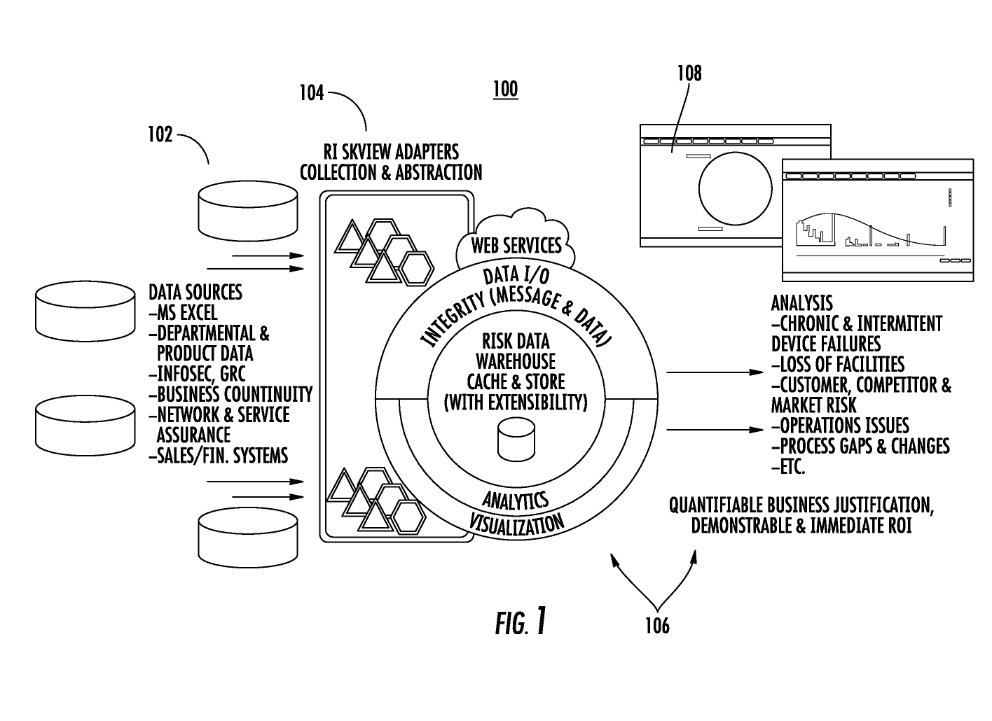

Now with respect to FIG. 1, an overall system representation 100 is provided. It shall be appreciated that each of the portions of the system may be practiced independently or in any combination. After an initial explanation of the overall system is provided, examples shall then be set out in order to illustrate the various achievements and features of the system. The examples shall be considered non-exhaustive case examples and not reflect all possible application of the proposed solution.

Now turning to the overall system shown in FIG. 1, there is shown a front end of the system with various examples of possible data sources 102, only some of which are shown here. These may be, without limitation, spreadsheets, department and product data, information security data, governance, risk and compliance data, business continuity data, sales data, phone calls, truck rolls, maintenance, or other telemetry. They may be in temporal, printed or electronic form, may be in a single or various locations, and may include instantaneous or historical data. As shown in FIG. 1, the information or data from data sources are collected or gathered and abstracted at 104.

A challenge MSOs often face is the “silo” nature of operations data sources that store or maintain outage risk data. Take as an example the case where the data source contains troubleshooting records from voice and data subscribers; a database with troubleshooting records from video subscribers; a database with truck rolls to subscribers; a database with physical plant maintenance truck rolls; and a database with network telemetry readings, etc. Generally, any of these databases are dissimilar enough that aggregate analysis of their data is time consuming and tedious. One aspect that the proposed solution resolves, and as shall be explained, is knitting together the various information from a stitch work of data sources.

In one aspect, this is accomplished by collecting a plurality of all of the risk data from across the MSO's business and service delivery infrastructure. Then the risks are normalized into a common format and language so they can be compared by assigning a unique score to each risk. Multiple records are used in one aspect to point to material concentrations of risk. An advantage of the risk concentration analysis methodology is classifying risk data in a meaningful way so that MSOs can see these concentrations. These “risks that matter” become evident when each risk is considered in the context of all other risks existing throughout the service delivery and support infrastructure.

As generally shown by 106, the proposed solution provides analytics for the collected and abstracted data or information. The methodology addresses in one aspect the reality that different risks have different impacts on the computer, software program, system or network. The analytics, thus, associate and provide analysis on concentrations of risk. With risk concentration analysis, material risks emerge when correlating risks from all data silos, self-contained sources that are difficult to data mine, and considering each risk in context of impact to the computer, software program, system or network. This approach yields scores, which may represent a monetary, good will or reputational value, making it easy to recognize and prioritize material risks.

In another aspect, the proposed solution provides analysis on service reliability. Service reliability is increasingly important, especially for business customers. In the quest for 99.999% service availability—or 5.3 minutes per year maximum downtime per customer—MSOs, such as in the cable space, have dedicated teams searching for subscriber outages. When these teams are provided with an automated aggregate view of outage risk, they spend less time marshaling data between databases and spreadsheets, and more time on geographically targeted analysis, maintenance and repairs. Mathematically, risk is defined as [the probability of an outage] times [the expected loss associated with the outage]. When there are multiple potential outages and different costs associated with them, the formula becomes:

$$Risk = {\sum }_{i}^{outages} [ probability of ith outage ] \times [ cost of ith outage ]$$

Thus, the proposed solution in addition or in the alternative provides analysis or a set of risk analytic tools that analyze the risk(s) or outage(s). It shall be appreciated that the risk analysis is provided as a tool in order to assist a human operator to comprehend and foresee more quickly the risk of an outage. In another aspect, risk concentration analysis aids in the ability to separate real detections from false alarms (i.e., Type I and Type II errors). A typical MSO may generate so many alarms that engineers and technicians may ignore them. By correlating, classifying and aggregating micro alarms, the MSO is provided with a very high probability of detection and a very low false alarm rate, alleviating a major drawback of current alarm technology.

In addition or in the alternative, there is provided a visualization tool 108 which may be in the form of an interface, graphical user interface (GUI), or portal. Any of which may be provided either in the field, such as on a truck call, or at the operator location. The visualization tool may be provided remotely through cloud or the internet, for example, or a closed network such as fixed networks or twisted pair. As shall be further explained, the visualization tool is adapted automatically according to the user or operator type. The type of user, user location, user authorization, user subscriber/customer, may be relevant, and the system provides a custom tailored adaption of the visualization based on these or any combination of user parameters. The visualization tool may also be configured according to operator type, which may include those given in the case examples, such as cable operator, CPE, manufacturer or financial, or may include further types.

Attention is now drawn to particular examples of the solution for different types of operators. It shall be appreciated that the above described system applies to each of the examples in general. However, the various examples themselves will have specific applications that arise from the general system solution. The first example shall consider the situation where the operator is a cable MSO. The second example shall consider the situation where the operator is a financial MSO. The third example shall consider the situation where the operator is a manufacturing MSO. Although particular examples will be discussed, it shall be understood that other types of operators are also applicable and relevant. It is further to be understood that any of the applications of the general solution within any particular example may be incorporated in any of the examples including other scenarios not mentioned. The examples shall be considered a non-exhaustive list of cases applying the general system.

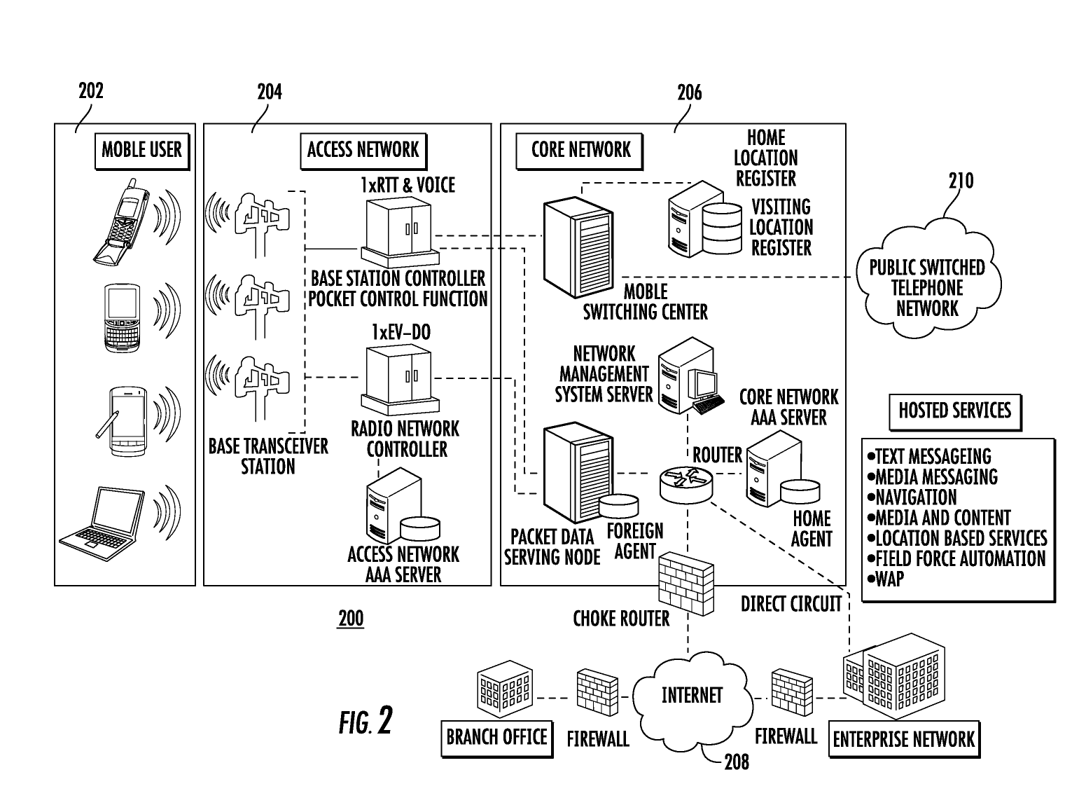

Now turning to the first example, a more detailed explanation shall be given to the example where the operator is a cable or telecom MSO. A typical cell or mobile network 200 is shown in FIG. 2 that includes mobile users 202, an access network 204 and a core network 206. The access network may include base stations and the core network may include a switching center as shown. The mobile network may further be connected to the internet 208 or to a public switched telephone network PSTN 210.

As an objective, the system sets out to assure at least one parameter is satisfied or optimized in the network area. This one parameter may include service and network reliability, that is how reliable a particular network or groups of networks are, and Outage Risk, or the risk that one or more networks or parts of networks go down or are not working properly. Further, it is typical for Telcos to allocate large numbers of engineers to handle problems and outages. Another parameter that is optimized according to the solution is the freeing up of these resources or engineers. In a wireless environment, such as a cellular network, reducing the number of incomplete call attempts and lost calls may be additional or unique parameters. Further parameters are shown in the Table 1 below:

TABLE 1

Percent Devices Offline
Per Port Errors
Per Device Errors
Non responders
Power Supplies
Poor/Failed Calls
Disconnects
Weighted Telemetry
And Others

Another useful source of information is telemetry data from in-home and in-business CPE devices such as cable modems and set-top boxes that support the DOCSIS (Data Over Cable Service Interface Specification). In concert with network elements such as cable modem termination systems, DOCSIS devices provide remote access to several metrics such as Uncorrectable Error Rates (UER), elevated reset behavior, and unusual online/offline behavior—on both the shared downstream and upstream channels as well as to and from each individual device. Depending on the frequency and magnitude of DOCSIS telemetry readings, the various levels of subscriber problems can be discerned.

Take, for example, the case where the DOCSIS telemetry information indicates a cable modem that spontaneously resets once a week. Further, the DOCSIS telemetry information indicates a modem that resets tens or hundreds of times per day. The proposed solution collects, identifies, classifies and analyzes this information and determines that the former modem is less of a problem for a subscriber than the latter. Not all cases are so straight forward; take the case where the DOCSIS information reveals a cable modem with −9 dBmV downstream receive power and a modem with −9 dBmV upstream receive power. The proposed solution determines that the latter modem is more problematic based on predetermined system configurations or parameters. In broadband most subscribers receive more data downstream, i.e., receiving content data for websites, than they send upstream.

The proposed solution further prioritizes problems and outages both past and future or both. For example, a cable modem or set of cable modems with high Uncorrectable Errors is more problematic than a similar set of modems with high Correctable Errors. But these may be of greater concern than a set of modems with very low numbers of Correctable Errors. Moreover, a high number of modems with small errors may be of more concern than a single modem with an uncorrectable problem.

The proposed solution uniquely classifies and scores DOCSIS CPE telemetry data to take into consideration those telemetry readings having greater impact to certain subscribers and which are perhaps not important to others. The data is given a value that may be thought of as greater importance or a higher reputational cost scoring. By so identifying this information, an aggregate tonnage of risk concentration can be calculated and then used to prioritize maintenance and repair efforts.

Thus, the solution identifies and classifies outages. For the present example, this may include the identification of chronically misbehaving devices which may not be found by current processes, for example. In a next step, the solution may isolate specific drivers of material outages that impact subscribers. It shall be appreciated that this provides a systematic approach to identifying problem spots in a network. The problems are thus documented and catalogued electronically and used to classify and assist with the later classification of problems in a network.

There may further be a correlation step that classifies or determines the correlation between alarms and incomplete call attempts and lost calls. The Table 2 below illustrates correlating data including, geography or location of the node, the particular switch, the BSM, the date and the time, and the type of problem or outage. Here is exemplified a problem with voice quality of service (QoS) in a wireless environment, here identified as a 2100 Voice Problem.

TABLE 2
Correlated data from telco alarm files and voice data statistics report:

| | |
|---|---|
| Geography: | Metroville |
| Switch: | MTX 01 (Ericsson) |
| BSM: | 05 |
| Date: | May 03, 2011 |
| Time: | 9:00 PM-9:59 PM (Alarm Report) |
| | 2100 (Voice Data Statistics Report) |

A scenario of how the proposed solution correlates subscriber call volume with DOCSIS telemetry shall now be described. It has been observed that a direct correlation can be built using the proposed solution between DOCSIS telemetry and the likelihood of troubled subscriber phone calls and truck rolls. To reiterate, DOCSIS telemetry may be used to identify a problem. Simply put, when DOCSIS telemetry is telling of a problem, the subscribers will eventually become unhappy and ultimately call for help. This drives up costs. In order to detect these subscriber-affecting network issues early and prevent loss of subscribers, the following plan in Table 3 may be put in place:

TABLE 3

| 1. | Identify Persistent Worst Nodes by “Connectivity” Call Volume only | |
|---|---|---|
| | for those serving areas where a network problem or | |
| | outage had not been declared, for example, in a 135-day | |
| | period. | |
| 2. | Tally the following “Connectivity” call types (per node total calls | |
| | and average calls shown): | |
| | a. | Internet - Loss of Connection, |
| | b. | Internet - No Connection, Signal Related, |
| | c. | Internet - Slow Speeds, |
| | d. | Voice - Loss of Dial Tone, |
| | e. | Voice - Intermittent Loss of Dial Tone, |
| | f. | Voice - Quality of Service (Voice Quality) Issue. |
| 3. | Plot Call volume and the following DOCSIS Telemetry Metrics by | |
| | day over time: | |
| | a. | Uncorrectable Codeword Error Rate (CER), |
| | b. | Elevated Reset behavior, and |
| | c. | Online/Offline behavior. |

An MSO, for example, experiences a fluctuation in call volume correlating to Uncorrectable Codeword Error Rate (CER). Similar correlation may be found across all nodes among DOCSIS metrics for CER, elevated device resets and time-varying online/offline status. The above Table 3 may reveal the surprising result that the worst node for slow speed call volume is not correlated with traffic, but with Uncorrectable Error Rates. If not for the correlation and the graphical mapping, the lingering issue might continue undetected for a longer period of time. With the above correlation that problem is more easily identified and fixed with pro-active maintenance activity, before affecting subscribers for several months at the significant capital expense of connectivity phone calls, plant visits and premises visits. In a typical cable MSO case, this may amount to a cost of approximately $7,000 plus subscriber churn.

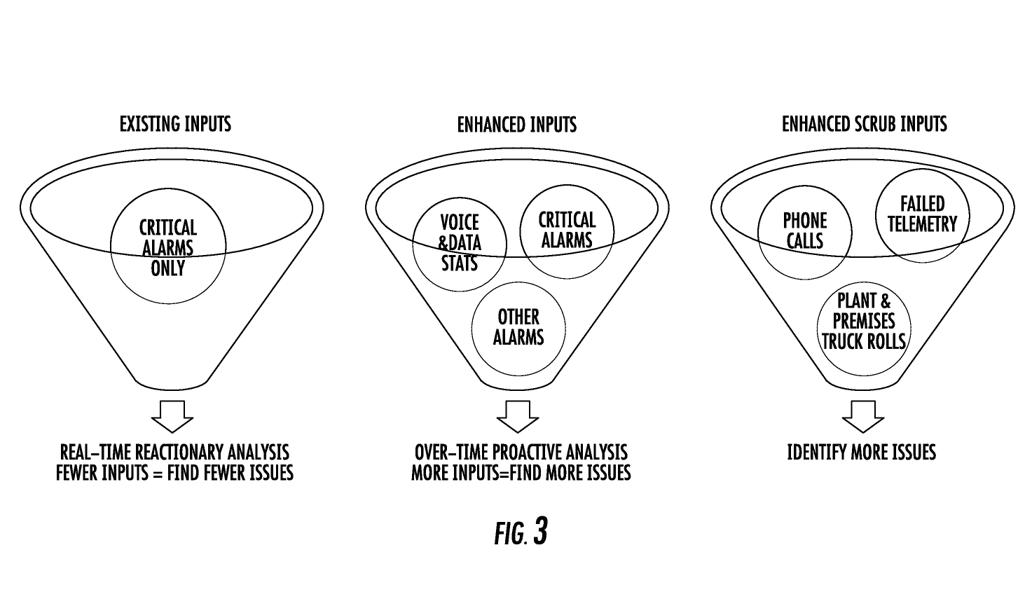

It shall be immediately appreciated that the present solution provides a superior method to that of the typical day to day problem identification approach. FIG. 3 summarizes some of the differences between the typical approach and the proposed solution of identifying and classifying problems or outages. As shall be appreciated the typical method is triggered by critical problems that arise in the network. This type of day to day checking may be considered to be reactionary or reactive and not pro-active. By contrast, the solution proposed here, and with particularity for this example, provides in addition to processing critical problems and outages, other faults as well such as voice and data problems. Such a system may be considered to be proactive. Further, it shall be appreciated that the typical solution does not represent the fourth dimension, time, as it provides no link between past or historical, present, or future data. On the other hand, the proposed solution offers not only instantaneous output, but also links problems or outages with past data to provide historical data, and may also provide future data in the form of predicted problems and outages. The result of the proposed solution is that not only more issues are found, but also the correct ones.

Cable operators also presently suffer from the aforementioned difficulties with processing problems and outages in a legacy cable system. The same holds true for other systems, such as Wireless networks. These latent systems are unequipped to provide over-time analysis, and they often overlook or misunderstand small and intermittent issues/outages that may go unchecked for extended periods. With the proposed solution, a system and methodology are provided for rooting out these problems, linking them together in an autonomous and intelligent manner, providing analysis, and visualizing the results to the user. Further, early and accurate identification of problems to the engineers in a timely fashion allows them to address issues in the field before they occur or become serious issues for the cable operator.

Now turning to the analysis portion of the proposed solution, there may be provided as part of the analysis step or a pre-analysis step a determination or assignment of a materiality score. While the materiality score is described here with respect to the present example, it shall be appreciated that the materiality score is applicable to any application of the solution for any operator, computer, software program, or network. The score of each risk reflects its calculated materiality to the business or subscriber—as well as the impact that problem would cause. In one aspect, the materiality score is reflected as a dollar value assigned to an asset or group of assets. The dollar value score may be based, not necessarily per se on the dollar cost of that asset, but on the materiality of having that asset or group go down or have problems. For example, in the Table 4 below, groups of assets are tabulated and scored on a dollar value that reflects the materiality of the problem or outage to that operator or network. The assigned dollar value could thus represent value, for example, good will or reputation, of an operator. For example, a group of phones, which may be a subset of all phones identified as particularly valued by the operator such as critical hotline phones, are assigned an $8 dollar value per fault. Truck rolls to critical regions of the hub may have a particular value as well over other truck rolls, here shown as $85 per truck roll.

Further, the materiality may be set relative to each other. For example, maintenance outages are shown here to have the highest value at $125 because a breakdown in maintenance services when nodes need repairing could result in severe network wide outages. If those outages are not repaired, the customers may end their contracts, and the operator may wind up out of business. Out of specification telemetry is given a relative less value since telemetric data is not as time critical as repairing the network. Rationally, larger telemetry errors affect the network more and are shown here to have a higher relative value at $3. On the other hand, other networks may consider that a collectively large amount of small errors may be more significant than a single instance of a large error. The materiality score multiplied by the occurrence here shows that the OOS errors outweigh in total, here calculated as $12, the grossly OOS errors, here $9.

TABLE 4

| | | | Cost per | | Total Financial |
|---|---|---|---|---|---|
| Input | Occurrences | × | Occurrence | = | Risk |
| Phone Calls | 13 | × | $8 | = | $104 |
| Truck Rolls | 8 | × | $85 | = | $700 |
| Maintenance | 2 | × | $125 | = | $250 |
| Out of Spec | 12 | × | $1 | = | $12 |
| (OOS) Telemetry | | | | | |
| Grossly OOS | 3 | × | $3 | = | $9 |
| Telemetry | | | | | |
| | | | | | $1,075/Street |

In one aspect, the dollar values may be considered fictitious, like monopoly money. They are set according to value and/or impact of the occurrence to a particular computer, software program, or network. They give, however, an appraisal of the severity of the problem in terms that the user can understand and compare to other problems. Further, the total value of the problems or outages are summed and reported, providing the user with the ability to obtain an overall value of the cost of running the network.

As shall be explained in more detail, the visualization tool identifies risks that one or more of these events indicate a network problem or outage. For example, when visualized with the visualization tool or report, the risks that represent the greatest vulnerabilities are delineated from the rest, making it easier for the user to quickly identify the largest problems or largest predicted problems. This helps Cable MSOs identify risks and then test controls in the context of all other risks, as opposed to looking at risks in isolation. For example, materiality identifies chronically misbehaving devices, recurring problems specific to a geographic region or departmental silo, or problems in program execution that are impacting the business's reputation or financial bottom line, etc.

It shall be appreciated that the proposed solution analyzes risks in the context of all other risks because isolated risk analysis does not always provide an effective way of looking at the larger picture. While isolated risk analysis evaluates each standalone tree, it ignores the much larger level of the forest. Additionally, isolated analysis lacks consistency and the ability to assign relative weights to risks, making it hard to compare risks from seemingly unrelated areas.

In another case example, the MSO may be a manufacturer. In this case, the focus may be on determining risk exposure and control cost/process relating to an assembly line. In this case example, the proposed solution identifies material concentrations of risk, within and across departmental silos, for example different portions of the assembly line, supply chain, marketing, sales, management, etc. The proposed solution targets the right risk controls and avoids spending on the wrong risk controls. In the manufacturing example, one industry or manufacturer may not be concerned as much on supply chain as another. A semiconductor manufacturer is, for example, more affected by a flood in Thailand at its backend facility then a wooden toy maker who may obtain wood from nearly anywhere. The proposed solution tailors the determination and classification of risk based on the impact to the particular entity. In addition, in the manufacturing case it may make more sense to provide pre-implementation models to test controls before they go on line. In that case, the present solution provides an ideal mechanism for providing various models of risk based on different assembly line roll outs.

In the financial sector, the proposed solution targets vulnerabilities and watches out that these do not outpace mitigating resources. To that end, the proposed solution may provide scoring technology for risks based on business impact, similar to the other scenarios. In this case, the data typically require normalization as there tend to be many computer servers and human touch points from various sources or financial institutions, each of which may have its own personally identifiable information, culture or jargon. The proposed system further draws data from multiple sources to prioritize mitigation efforts and resources. This reduces the amount of work that a financial operation must concern itself with and provides, for example, better and more timely compliance reports.

Attention shall now be turned to the visualization tool that may be provided as part of the proposed solution. As shall be discussed, the visualization tool may provide either an interface or portal, or a report, or both. The visualization tool may be adaptive such that it changes with regard to the user or the subscriber. Thus, for example, the interface or portal may be a complete interface or a mini-portal designed for compact access, such as on a mobile device. The report may change in order to have a look and feel that supports the efficacy of the user. For example, an engineering analyst or technician may have key focus points directed to network problems and outages, whereas the report for the management level may be adapted by the proposed solution to focus on the value analysis which may be more relevant to the business bottom line contribution of the computer, software program, or network.

Thus, the proposed visualization tool provides flexibility. This may further be based on user needs and type of outage investigation, but also or in the alternative on certain outage types. Some outage types may be easier to detect than never-before-seen outages, and flexibility assists to group and view the problems in different ways. In one aspect, the various views provides a specific recommendation or marker, such as “Drill Here”, in order to alert that operations should have a closer look specifically at one of more of the marked problems. These problems may be delineated on the interface or report by parameters shown in Table 5 below:

TABLE 5

| | |
|---|---|
| a. | Geographical Area: Market, Hub, Node, Last Active Amplifier |
| | or Street; |
| b. | Customer Premise Equipment: Make/Model/Hardware/Firmware/ |
| | Software; |
| c. | “Mother Ship” Network Element: CMTS, DNCS, DHCP Server, |
| | DNS Server, Soft Switch, etc.; |
| d. | Product or Service: Voice, Voice Mail; Video, VOD; Data, etc . . . |

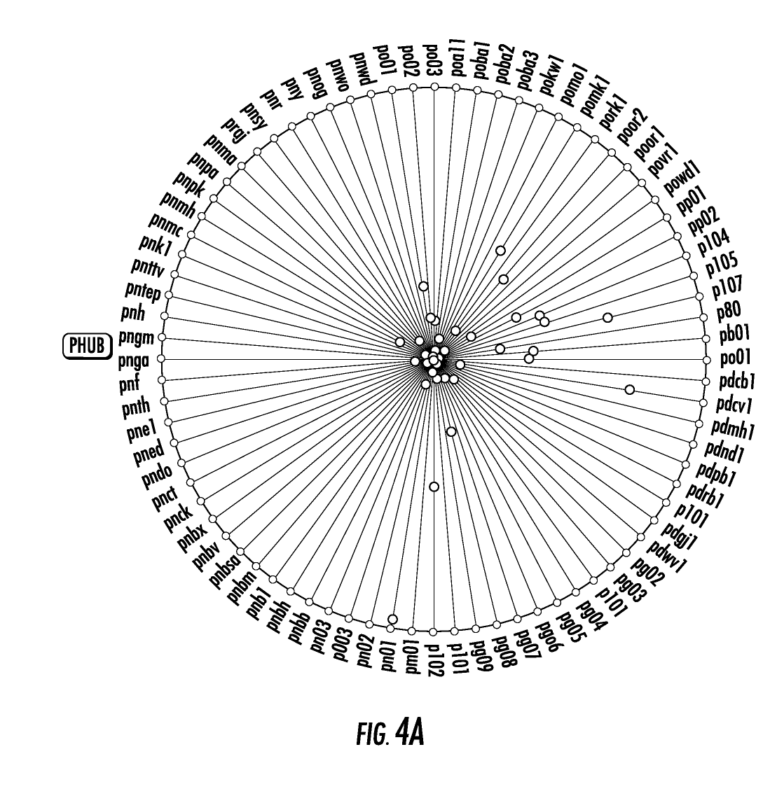

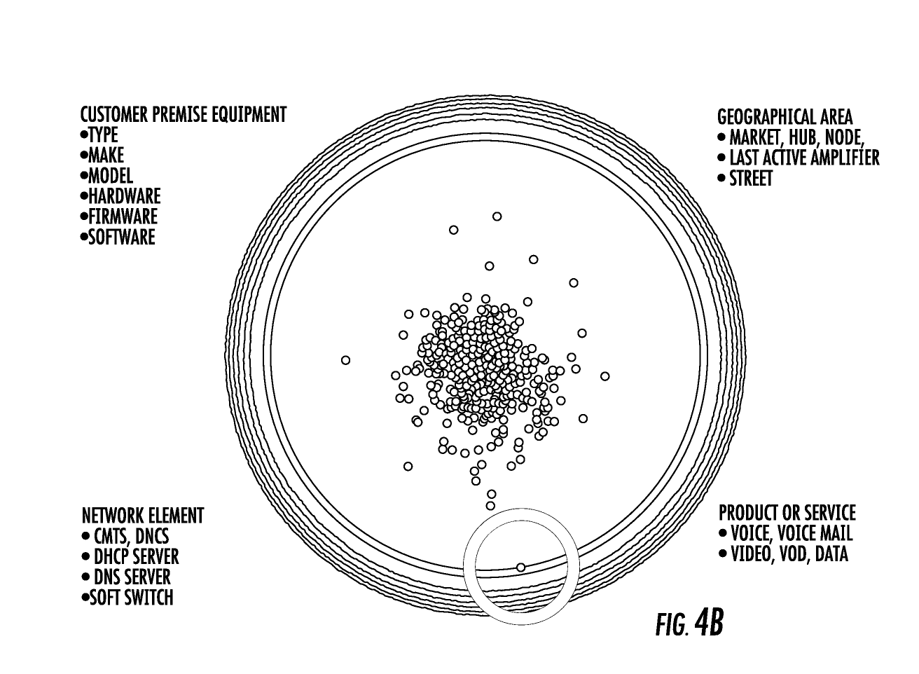

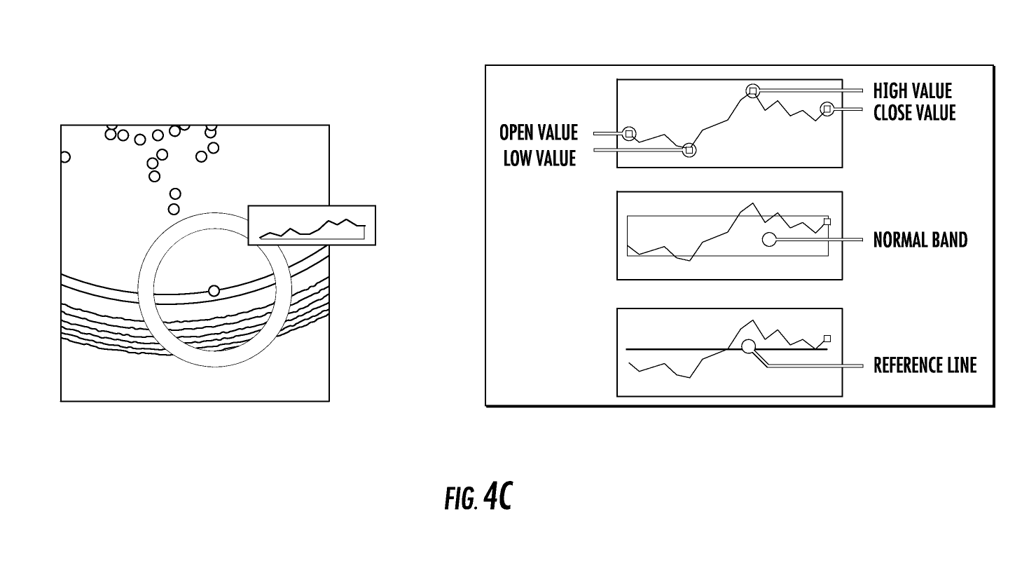

FIG. 4A illustrates a possible type of interface or port, or may also be provided as a report, which further may be arranged as an interactive user interface. In this instance, the interactive interface provides a view of hubs of a cable operator. In one aspect, a polar or radial diagram orientation may be used, wherein the distance from the center or edge may indicate a network problem or outage. In the present example, the points closest to the outer edge indicate problem hubs. In this manner, the user is given an immediate visualization clue that the particular hub is experiencing or will experience problems or outages in the future.

FIG. 4B illustrates another view that may be an alternative or provided as another view to FIG. 4A. The present view may be a view of all the nodes in the worst hub (circled in red), for example. In FIG. 4B there are hundreds of nodes portrayed. Note again how the top outliers—the worst nodes in the worst hub—clearly stand out. In either figure, each dot may represent the aggregate normalized Financial, Legal or Reputational outage risk cost.

FIG. 4C illustrates another feature that may be in addition to or in the alternative to the proposed solution and/or its several components. In this case, there may be provided a spark-lines or graph that pops up on, for example, mouseover. These spark line provide addition aspects into the time dimension, providing historical data to the user for one, more or all data points. There may be provided reference points or lines in the spark line, a normal band and/or threshold values, such as maxima and minima.

Another way to view Outage Risk is by way of reports that are most useful when insights from exploratory analysis in the user Interface have made the outage easy to find systemically. Reports may be constructed for specific audiences of fix agents and/or locations, such as the “Department Head of Field Service in Syracuse.” Reports may be run on-demand or on a periodic basis every Day, Week, Month, Quarter, or Year. Reports may be automatically emailed and are easily viewed in Microsoft Excel. Reports may be extremely flexible and can be configured to identify, for example, the Top 10 Worst or Top 10 most materially changed (increased or decreased) Markets, Hubs, Nodes, Last Active Amplifiers, and Streets, either system-wide or by specific Management Area(s).

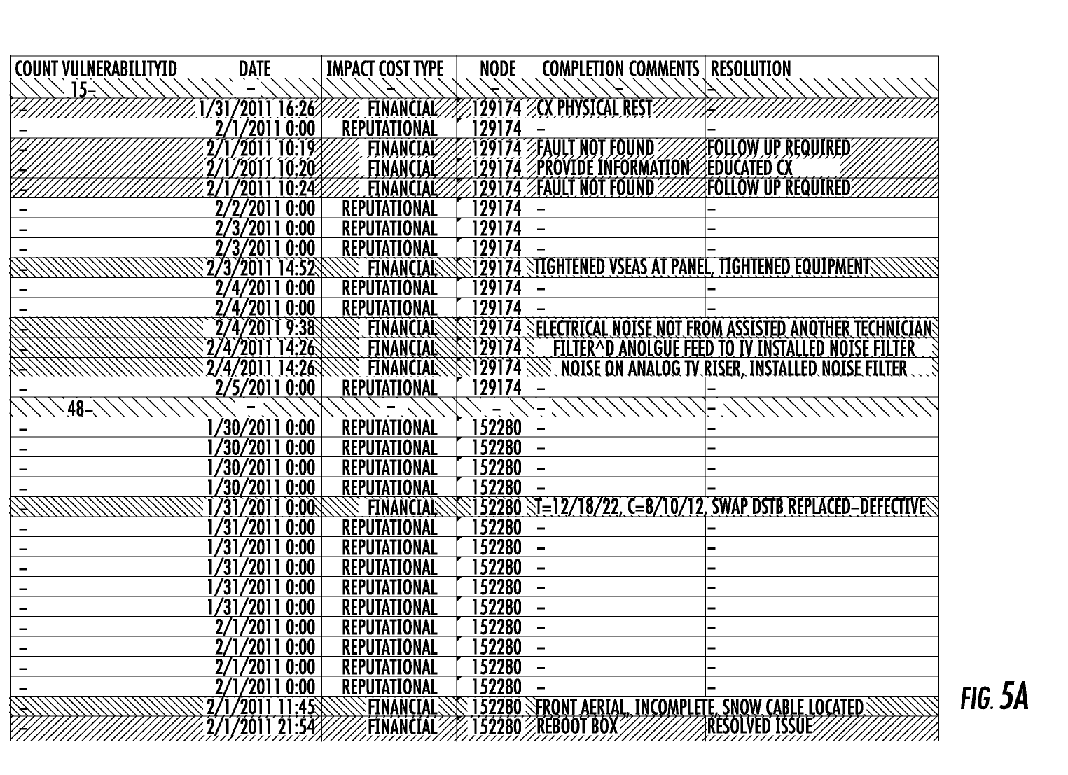

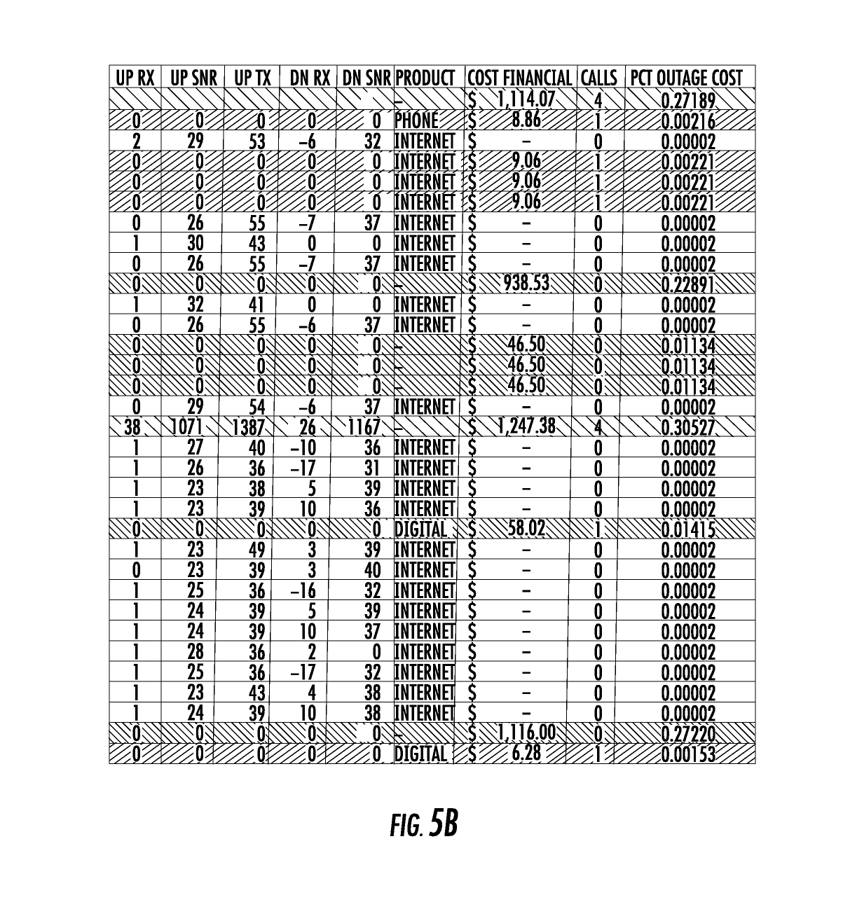

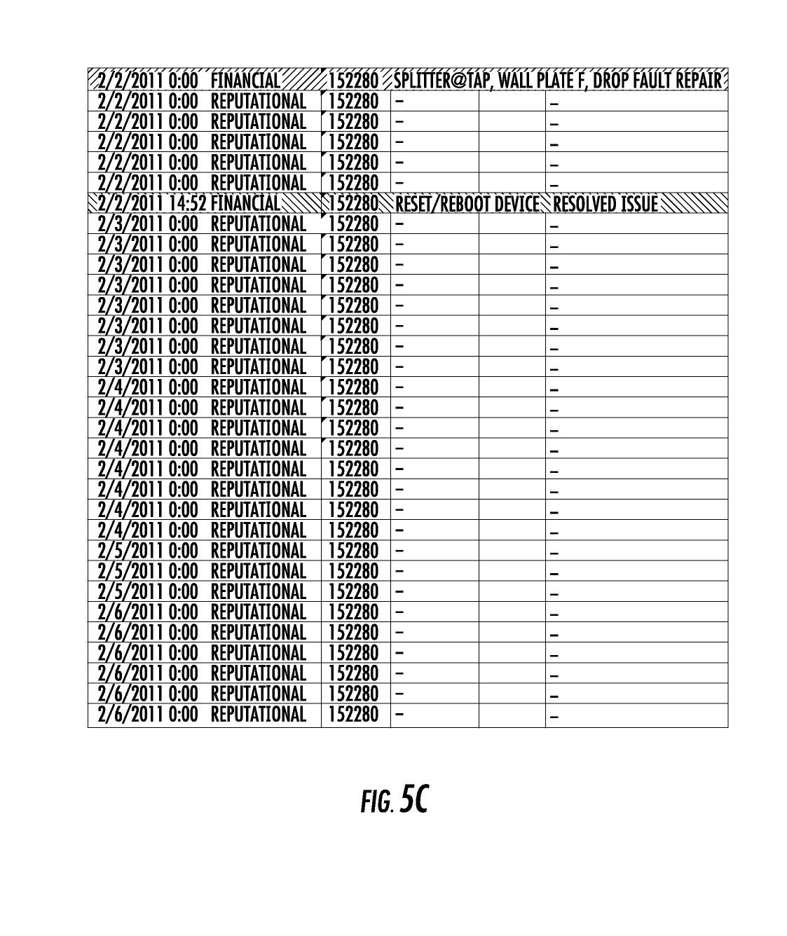

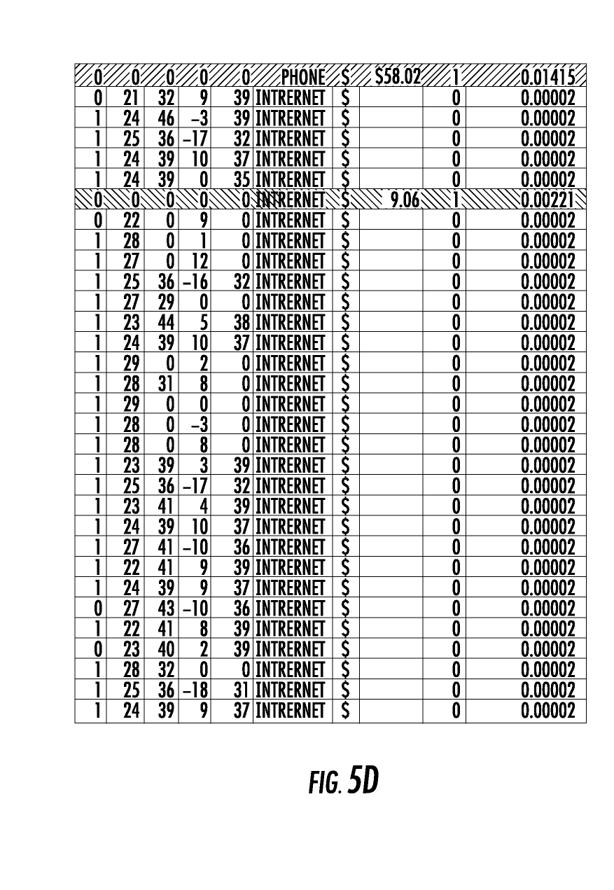

Any number of Classifications may be used: by Asset, by Product, by Trouble Type, by Fix Activity, in the alternative or in the addition to Reputational, Legal and Financial scoring. Further, the classification may be any number or any combination of these classifications. The sample report in FIGS. 5A-5D is from the Top 2 Worst Nodes in FIG. 4B in an Entire Cable System and includes, for example, a color coded reporting scheme:

a. Troubled Subscriber Phone Calls and Truck Rolls in Red,

b. Telemetry Data from MAC Addresses in White,

c. Plant Maintenance Truck Rolls in Yellow.

It shall be appreciated that the far right columns illustrate Financial and Reputational (Outage) Costs. Also of note is that Node 129174 phone calls and truck rolls dominated failed telemetry readings, and in Node 152280 failed telemetry readings dominated phone calls and truck rolls. The reports may be arranged to illustrate worst cases at the top or bottom of the list, for example. The report may also be constructed in any number of ways in order to illustrate worst or best performers or those that have changed position most since the prior report.

Another way to view Outage Risk is by mini-report. For example, texting to a mobile phone or a hand held PDA or field engineer mobile test unit. Further, the mini-report may be provided as an auto-alarm generation and email distribution. Alarms may have the same look and feel as reports and are based on specific queries that, if any results are returned, send a clear message, for example, “mobilize now!”

In addition, a report may be generated providing a return on investment analysis. In the systemic treatment of undetected outages, for example, a value is realized in one or more of the following areas:
a. Groups that perform outage detection and analysis:

These groups are tasked with finding outages and answering the question “why did a certain event occur for a significant amount of time without an outage ever being declared?” These groups are then tasked with creating new queries to automatically declare outages (i.e., pull the fire alarm) usually after an irate subscriber calls or emails, the CEO, or a financial analyst notices an unusual spike in truck rolls in a specific region or an abnormally high percentage of calls related to a specific product. Without the benefit of Risk Concentration Analysis, this process may take weeks or months of sifting through data and building Microsoft Excel macros, sorting filters and spreadsheets.

Reducing the time to resolve and understand causes of issues to 25% of the typical time required increases the value of these groups substantially.
b. Engineering, customer service and network operations:

Engineering, customer care and network operations organizations are asked to resolve issues due to failed architectures, equipment or applications. Better understanding subscriber-affecting problems extends the capabilities of these organizations by approximately an additional 75%.
c. Enterprise: Ability to optimize spending to the areas that impact the most subscribers vs. “one-offs or squeaky wheels” significantly improves the customer experience and improves overall operational efficiencies of the MSO. The continued positive impact of fact-based decision-making on enhancements and new initiatives pays dividends for years into the future.

By using a framework and visualization engine based on next-generation data aggregation and correlation, Cable MSOs can identify chronically failing equipment, prioritize preventative maintenance, and find and prevent outages. Cable MSOs are able find outages that are otherwise “under the radar” and hurting subscribers.

Systemic treatment identifies how outage risks map together using the proposed solution. Analyzing outage events and associated network health telemetry metrics quickly isolates specific drivers of material outage—the outages that matter. This illustrates to the Cable MSOs recognizable patterns of system-wide issues in the service delivery infrastructure, and reduces truck rolls and repeat service calls.

The risk concentration analysis solution provided is capable of providing a straightforward return on its value to MSOs. On average, MSOs expect at least a 1.5% reduction in technical calls per month and an associated 1.5% reduction in truck rolls related to trouble calls per month. For an MSO with 1 million subscribers, that represents a reduction of approximately 5,000 calls per month and 1,000 truck rolls per month. For a large MSO, that may be projected as an overall Net Present Value of $1.2m. The NPV included measurable before and after savings attributed to preventing thousands of phone calls, truck rolls, ticket handoffs, repeat tickets and customer credits, and close to 2 million preventable subscriber outage minutes.

A solution is thus provided in one aspect by carefully classifying, scoring and combining maintenance activities, telephone calls from troubled subscribers, truck rolls and network telemetry—resulting in timely identification of otherwise undetected outages. As a result, with aggregate outage risk concentrations clearly portrayed and delivered to the proper audiences, Cable MSOs are able to find and fix the most critical outages as soon as possible and can also fix more outages faster, reduce costly phone calls and truck rolls, reduce subscriber churn (especially from high-revenue customers) and improve overall service reliability.

One skilled in the art shall appreciate that the proposed solution is not relevant only to the examples given here, but any computer, software program, or network needing assistance in identifying and predicting risks of problems or outages. Further, and as discussed, any of the methodologies or solutions herein may be operated independently or in combination irrespective of the type of operator. The proposed solution may also be applied to quantify the ROI benefit of systemic treatment of undetected outages in complementing existing MSO operational “right now” outage detection. Another applicable area is to propose solutions for aggregating and processing “No Trouble Found” data using the proposed solution. Further development of systemic filters to identify, classify and score both impact and nonimpact failures (i.e., those that do/do not have material impact on subscribers), to further prioritize those failures that impact the delivery of services is also with the scope of the proposed solution. There is also provided the development of a sophisticated mapping system that enables the pinpointing of trouble-areas according to a visualization of their precise geographical location, down to the street level.

In the description herein, reference is made to a number of terms which are defined here for guidance purposes only and do not serve to limit these terms, but rather provide a point of reference to present a context in which the provided solutions may be better understood.

CC—Call Center A centralized office operated by a cable company or other operator to administer service-based support and information inquiries from subscribers.

CER—Codeword Error Rate A technique that measures reliable delivery of digital data. Many communication channels are subject to channel noise so errors may be introduced during transmission from the source to a receiver.

Cloud—A model for enabling ubiquitous, convenient, on-demand network access to a shared pool of configurable computing resources (e.g., networks, servers, storage, applications and services).

CPE—Customer Premises Equipment Refers to equipment located at a subscriber's premises and connected with a carrier's telecommunications channels. Generally includes devices such as telephones, routers, switches, set-top boxes, fixed mobile convergence products, home networking adapters and Internet gateways that enable subscriber's access to services from the home.

DOCSIS—Data Over Cable Service Internet Specification An international telecommunications standard that permits the addition of high-speed data transfer to an existing CATV system. It is employed by many Cable MSOs to provide Internet access over their existing infrastructure.

Financial Risk—An umbrella term for any risk associated with any form of financial risk. Risk is often taken as downside risk, the difference between the actual return and the expected return (when the actual return is less) or the uncertainty of that return. In an operator environment, such as the Cable MSO world, financial risk is calculated using metrics such as truck rolls, call center calls, and churn rate.

MSO—Multi-System Operator An operator of multiple computers, software programs, networks, or systems. As an example, this includes any cable company that serves multiple communities is an MSO.

Network Telemetry A technology that allows remote measurement and reporting of information. Although the term commonly refers to wireless data transfer mechanisms (e.g. radio), it also encompasses data transferred over other media, such as a telephone or computer network, optical link or other wired communications.

NOC—Network Operations Center A NOC is one or more locations from which control is exercised over a computer, television broadcast or telecommunications network.

NTF—No Trouble Found A term used in various fields, especially in electronics, referring to a system or component that has been identified for repair but operates properly when tested. This situation is also referred to as No Defect Found (NDF) and No Fault Found (NFF).

NPV—Net Present Value In finance, the Net Present Value of a time series of cash flows, both incoming and outgoing, is defined as the sum of the Present Values (PVs) of the individual cash flows of the same entity.

Outage Risk—The likelihood that a service will be disrupted at some point during its transmission, preventing it from being delivered to its destination subscriber.

RCA—Risk Concentration Analysis Material risks emerge when correlating risks from all silos and considering each in context. The RCA approach yields a Materiality Score, making it easy to recognize and prioritize material risks—the risks that matter. After collecting vulnerability data from throughout the business, RCA software assigns a score to each “risklet” that reflects its likelihood to cause a problem—as well as the impact that problem would cause.

Reputational Risk Reputational risk is related to the trustworthiness of the business. Damage to a firm's reputation can result in lost revenue or destruction of shareholder value, even if the company is not at fault. Metrics used to calculate reputational risk in the Cable MSO world, for example, include the number of subscribers impacted, the number of services impacted and the number of outage minutes.

RGU—Revenue Generating Units An individual service subscriber that generates recurring revenue for a company. Cable and telephone companies generally break down their subscribers into RGUs.

QoS—Quality of Service Quality of Service comprises threshold requirements on all of the aspects of a connection, such as service response time, loss, signal-to-noise ratio, cross-talk, echo, interrupts, frequency response, loudness levels, etc.

Truck Rolls Refers to the act of dispatching a technician or truck to resolve a service problem, usually at a home or street location. Truck roll volume is monitored closely by MSOs because it comprises a large percentage of operating expenditures.

UER—Uncorrectable Error Rate A metric for determining the data corruption rate in a telecommunications transmission. UER may be considered to be the number of data errors discovered after applying any specified error-correction method.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

1. An apparatus for generating a prediction warning when a future operational disturbance is predicted in a network, the apparatus comprising:
a classifier that classifies problems or outages of a network according to an impact that the problem or the outage has on the network;
an analyzer that analyzes data and establishes links between network problems or outages, the analyzer outputs a probable monetary cost of a future network problem or outage; and
a reporting unit that reports the prediction warning indicating a future operational disturbance of the network problem or outage in a format that is selected based on a type of user.

2. The apparatus according to claim 1, further comprising a database that stores information relating to network problems or outages from a plurality of data sources.

3. The apparatus according to claim 2, further comprising a collecting unit that collects the information autonomously from the plurality of data sources.

4. The apparatus according to claim 1, wherein the data sources are selected from the group consisting of printed matter, electronic data stored in a database, and telemetry data.

5. The apparatus according to claim 1, further comprising a materiality unit that assigns a materiality score to a particular network problem or outage based on the materiality of that problem or outage to the network, wherein the materiality is based on an absolute or relative value or rate of change.

6. The apparatus according to claim 2, further comprising a normalizing unit that normalizes the information from the plurality of data sources in a manner that the information conforms to a common scoring and syntax.

7. The apparatus according to claim 1, wherein the network is selected from the group consisting of a smartphone, a tablet computer, a laptop, computer, a desktop computer, a server computer, a data center, a cable network, a mobile network, a telecommunication network, a manufacturing line, and a financial services network.

8. The apparatus according claim 1, wherein the reporting unit generates a report as a polar coordinate chart indicating an importance of the predicted warning of the network problems or outages by arrangement on the polar coordinate chart.

9. The apparatus according claim 1, wherein the type of user is selected from the group consisting of an analysis engineer, a field engineer, a technician, a fix agent, and a manager.

10. The apparatus according to claim 1, wherein the classifier further classifies assets of the network.

11. The apparatus according to claim 10, wherein the reporting portion further provides a spark line mouseover in a form of a graph indicating a history of network problems or outages for a particular asset.

12. A method for generating a prediction warning indicating that a network will experience a future operational disturbance, the method comprising the steps of:
classifying network problems or outages according to an impact that the problem or outage has on the network;
analyzing the data and establishing links between isolated network problems or outages that together represent a likelihood of a future network problem or outage; and
reporting the prediction warning indicating a future operational disturbance network problem or outage in a format that is selected based on a type of user.

13. The method according to claim 12, further comprising the step of gathering data in a database that stores information relating to network problems or outages from a plurality of data sources.

14. The method according to claim 13, further comprising the step of collecting the information autonomously from the plurality of data sources.

15. The method according to claim 12, wherein the data sources are selected from the group consisting of printed matter, electronic stored in a database, and telemetry data.

16. The method according to claim 12, further comprising the step of assigning a materiality score to a particular computer, software or network problem or outage based on the materiality of that network problem or outage to the network, wherein the materiality is based on an absolute or relative value or rate of change.

17. The method according to claim 13, further comprising the step of normalizing the information from the plurality of data sources in a manner that the information conforms to a common syntax.

18. The method according to claim 12, wherein the network is selected from the group consisting of a smartphone, a tablet computer, a laptop, computer, a desktop computer, a server computer, a data center, a cable network, a mobile network, a telecommunication network, a manufacturing line, and a financial services network.

19. The method according to claim 12, wherein the step of reporting generates a report as a polar coordinate chart indicating an importance of the predicted computer, software or network problems or outages by arrangement on the polar coordinate chart.

20. The method according to claim 12, wherein the type of user is selected from the group consisting of an analysis engineer, a field engineer, a technician, a fix agent, and a manager.

21. The method according to claim 11, wherein the classifying step further classifies the assets of the network.

22. The method according to claim 21, wherein the step of reporting further providing a spark line mouseover in a form of a graph indicating a history of network problems or outages for a particular asset.
